(19) United States
(12) Patent Application Publication
(10) Pub. No.: US 2026/0030021 A1
(43) Pub. Date: Jan. 29, 2026

(54) SYSTEMS AND METHODS FOR CONDENSING MESSAGES ASSOCIATED WITH SOFTWARE RELEASE NOTES

(71) Applicant: Capital One Services, LLC, McLean, VA (US)

(72) Inventors: Lavanya GOWLLA, Bangalore (IN); Lavanya RAJA, Bangalore (IN); Puneet GOYAL, Bangalore (IN); Ajay SYAMALADEVI, Bangalore (IN); Aniruddh PREMDAS, Bangalore (IN); Daksh SHARMA, Bangalore (IN); Roshni SINGH, Plano, TX (US); Uday SINGH, Bangalore (IN)

(73) Assignee: Capital One Services, LLC, McLean, VA (US)

(21) Appl. No.: 18/781,049

(22) Filed: Jul. 23, 2024

(51) Int. Cl. G06F 8/73

(52) U.S. Cl. CPC G06F 8/73

(57) ABSTRACT

Systems and methods for condensing messages associated with software release notes. In some aspects, the system may identify messages relating to a document. The system may determine, within a subset of the messages, one or more references to one or more portions of the document. The system may process, using a co-referencing model, the document and the subset of the plurality of messages to determine an antecedent to which each reference refers. The system may determine, based on predictions generated by the co-referencing model, that both a first message and a second message of the subset of the messages refer to a particular antecedent. Based on determining that the first message and the second message are within a threshold similarity of each other, the system may modify the document to remove the second message from the document.

### SUMMARY

Collaborative documents may receive edits and comments from multiple contributors. For example, a collaborative document may be release notes for a software release, and contributors may include multiple developers. Certain comments from developers may be duplicative of other comments, but it may be difficult to identify duplicative comments. For example, comments may include different references to the same antecedent and may thus appear dissimilar to one another despite their redundant meanings. Such duplicative comments may obfuscate the meaning of the comments, making it difficult to interpret the comments. Thus, a mechanism is desired for condensing messages associated with release notes to remove redundancies.

Methods and systems are described herein for condensing messages associated with release notes. A data condensing system may be built and configured to perform operations discussed herein. The data condensing system may identify, within a document, messages relating to the document. The data condensing system may determine, within several of the messages, references to one or more portions of the document. For example, the references may include pronouns, demonstratives, and nominal phrases that refer to portions of the document. The data condensing system may use a co-referencing model to determine an antecedent to which each reference refers. In some embodiments, the data condensing system may determine that two different messages refer to the same antecedent. If the meanings of the two different messages are similar enough, the data condensing system may modify the document to remove one of the messages. Data condensing system may thereby remove redundant messages that do not appear to be redundant from the document.

In particular, the data condensing system may identify, within a document generated for release (e.g., release notes), messages from users. In some embodiments, the messages may be comments from developers. For example, the comments may relate to the document, which may be a collaborative document. The comments may include references to the document or to other comments. For example, the references may include pronouns, demonstratives, nominal phrases, or other references to the document or comments. Each reference may refer to an antecedent within the document or comments. As an example, a reference (e.g., “this”) may refer to an antecedent within the document (e.g., a section of the document).

The data condensing system may determine that a subset of the messages includes such references. For example, only certain messages within the document may include references to antecedents within the document or within other messages. The data condensing system may process the document and the subset of messages to determine an antecedent to which each reference refers. For example, the co-referencing model may be trained to predict antecedents based on references within text.

The data condensing system may determine, based on predictions generated by the co-referencing model, that both a first message and a second message of the subset of messages refer to the same antecedent. For example, a first message may include “I don't know if we need the final part,” while a second message may include “Let's remove this.” Based on the predictions generated by the co-referencing mode, the data condensing system may determine that “the final part” and “this” refer to the same antecedent (e.g., a section of the document).

The data condensing system may then determine a first meaning and a second meaning of the first message and the second message, respectively, relating to the particular antecedent. For example, two messages may refer to the same antecedent but may have different meanings (e.g., “I don't know if we need the final part” and “I think we should keep it”). In some embodiments, the data condensing system may determine the meaning using a natural language processing model. For example, the data condensing system may determine that “I don't know if we need the final part” and “Let's remove this” have similar meanings.

Based on determining that the first meaning and the second meaning are similar enough, the data condensing system may modify the document to remove one of the messages from the document. For example, the data condensing system may remove “I don't know if we need the final part” or “Let's remove this” from the document. In some embodiments, the data condensing system may determine which message has a more concise meaning (e.g., based on the outputs from the natural language processing model. The data condensing system may then remove the message which the less concise meaning. In this example, the data condensing system may remove “I don't know if we need the final part” from the document and may leave “Let's remove this” in the document.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative system for condensing messages associated with release notes, in accordance with one or more embodiments.

FIG. 2 illustrates an exemplary machine learning model, in accordance with one or more embodiments.

FIG. 3 illustrates a document with messages associated with the document, in accordance with one or more embodiments.

FIG. 4 illustrates relationships between references and antecedents, in accordance with one or more embodiments.

FIG. 5 illustrates a modified document with messages associated with the modified document, in accordance with one or more embodiments.

FIG. 6 illustrates a computing device, in accordance with one or more embodiments.

FIG. 7 shows a flowchart of the process for condensing messages associated with release notes, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

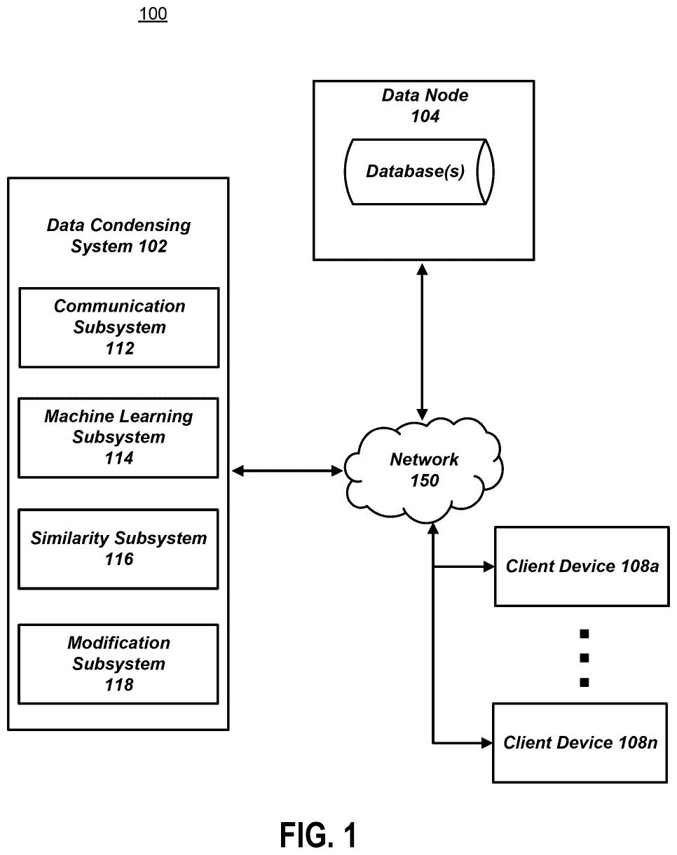

FIG. 1 shows an illustrative system 100 for condensing messages associated with release notes, in accordance with one or more embodiments. System 100 may include data condensing system 102, data node 104, and client devices 108a-108n. Data condensing system 102 may include communication subsystem 112, machine learning subsystem 114, similarity subsystem 116, modification subsystem 118, and/or other subsystems. In some embodiments, only one user device may be used, while in other embodiments, multiple user devices may be used. The client devices 108a-108n may be associated with one or more users or one or more user accounts. In some embodiments, client devices 108a-108n may be computing devices that may receive and send data via network 150. Client devices 108a-108n may be end-user computing devices (e.g., desktop computers, laptops, electronic tablets, smartphones, and/or other computing devices used by end users). Client devices 108a-108n may (e.g., via a graphical user interface) run applications, output communications, receive inputs, or perform other actions.

Data condensing system 102 may execute instructions for protecting client data from malicious actors while training machine learning models. Data condensing system 102 may include software, hardware, or a combination of the two. For example, communication subsystem 112 may include a network card (e.g., a wireless network card and/or a wired network card) that is associated with software to drive the card. In some embodiments, data condensing system 102 may be a physical server or a virtual server that is running on a physical computer system. In some embodiments, data condensing system 102 may be configured on a user device (e.g., a laptop computer, a smart phone, a desktop computer, an electronic tablet, or another suitable user device).

Data node 104 may store various data, including one or more machine learning models, training data, communications, and/or other suitable data. In some embodiments, data node 104 may also be used to train machine learning models. Data node 104 may include software, hardware, or a combination of the two. For example, data node 104 may be a physical server, or a virtual server that is running on a physical computer system. In some embodiments, data condensing system 102 and data node 104 may reside on the same hardware and/or the same virtual server/computing device. Network 150 may be a local area network, a wide area network (e.g., the Internet), or a combination of the two.

Data condensing system 102 (e.g., machine learning subsystem 114) may include or manage one or more machine learning models. Machine learning subsystem 114 may include software components, hardware components, or a combination of both. For example, machine learning subsystem 114 may include software components (e.g., API calls) that access one or more machine learning models. Machine learning subsystem 114 may access training data, for example, in memory. In some embodiments, machine learning subsystem 114 may access the training data on data node 104 or on client devices 108a-108n. In some embodiments, the training data may include entries with corresponding features and corresponding output labels for the entries. In some embodiments, machine learning subsystem 114 may access one or more machine learning models. For example, machine learning subsystem 114 may access the machine learning models on data node 104 or on client devices 108a-108n.

Machine learning subsystem 114 may include one or more co-referencing models. In some embodiments, co-referencing models may identify and link various entities (e.g., antecedents) across text, ensuring that references to the same entity, despite differing expressions, arc understood as being the same. Co-referencing models may analyze context, grammatical structures, and semantic relationships within a given text. In particular, these models may analyze sentences to identify noun phrases and may apply machine learning algorithms to predict which phrases refer to the same entities. Co-referencing models may utilize features such as grammatical role, number agreement, and proximity to other entities to improve their predictions. A co-referencing model may employ natural language processing techniques to discern and connect references to the same entity, whether they appear as pronouns, names, or descriptive phrases. In some embodiments, co-referencing models may leverage deep learning techniques, such as neural networks, to better understand context. For example, a co-referencing model may utilize embeddings that capture semantic similarities between words, enabling the model to infer that different terms refer to the same entity based on their usage in similar contexts.

Machine learning subsystem 114 may include one or more natural language processing (NLP) models. NLP models may leverage a variety of computational methods to understand and generate human language. NLP models may utilize tokenization to dissect text into smaller units, such as words or phrases, and may apply part-of-speech tagging to categorize these tokens according to their function in sentences. Dependency parsing may also be employed to analyze the grammatical structure of sentences, helping the NLP models to understand how different words relate to each other. NLP models may use machine learning algorithms, particularly deep learning, to process and interpret language. They may employ neural networks, such as Recurrent Neural Networks (RNNs) or the more advanced Transformers, to process sequences of words and capture the context over longer stretches of text. NLP models may use attention mechanisms to weigh the importance of different words in a sentence, enabling them to focus on relevant parts of the input while generating responses or making predictions. NLP models may employ word embeddings to convert words into numerical vectors that capture semantic similarities and relationships between terms. By training on large corpora of text, NLP models may learn nuanced language patterns, allowing them to perform complex tasks such as sentiment analysis, machine translation, or question-answering.

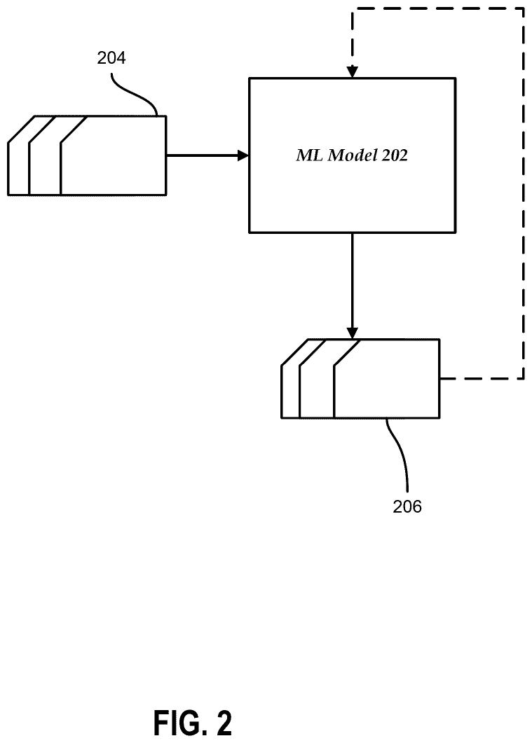

FIG. 2 illustrates an exemplary machine learning model 202, in accordance with one or more embodiments. In some embodiments, machine learning model 202 may be included in machine learning subsystem 114 or may be associated with machine learning subsystem 114. As an example, machine learning model 202 may represent a co-referencing model, an NLP model, or another type of model. Machine learning model 202 may take input 204 and may generate outputs 206. The output parameters may be fed back to the machine learning model as inputs to train the machine learning model (e.g., alone or in conjunction with user indications of the accuracy of outputs, labels associated with the inputs, or other reference feedback information). The machine learning model may update its configurations (e.g., weights, biases, or other parameters) based on the assessment of its prediction (e.g., of an information source) and reference feedback information (e.g., user indication of accuracy, reference labels, or other information). Connection weights may be adjusted, for example, if the machine learning model is a neural network, to reconcile differences between the neural network's prediction and the reference feedback. One or more neurons of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the machine learning model may be trained to generate better predictions of information sources that are responsive to a query.

In some embodiments, the machine learning model may include an artificial neural network. In such embodiments, the machine learning model may include an input layer and one or more hidden layers. Each neural unit of the machine learning model may be connected to one or more other neural units of the machine learning model. Such connections may be enforcing or inhibitory in their effect on the activation state of connected neural units. Each individual neural unit may have a summation function, which combines the values of all of its inputs together. Each connection (or the neural unit itself) may have a threshold function that a signal must surpass before it propagates to other neural units. The machine learning model may be self-learning and/or trained, rather than explicitly programmed, and may perform significantly better in certain areas of problem solving, as compared to computer programs that do not use machine learning. During training, an output layer of the machine learning model may correspond to a classification of machine learning model, and an input known to correspond to that classification may be input into an input layer of the machine learning model during training. During testing, an input without a known classification may be input into the input layer, and a determined classification may be output.

Returning to FIG. 1, data condensing system 102 (e.g., communication subsystem 112) may identify, within a document, a plurality of messages. In some embodiments, the plurality of messages relates to the document. In some embodiments, the plurality of messages may be received from a first plurality of users. In some embodiments, each message may be associated with an author (e.g., a user of the first plurality of users). In some embodiments, the messages may be stored within the document. In some embodiments, the messages may be stored separately (e.g., on a separate platform) and may be associated with the document. In some embodiments, the messages may connect to one or more portions of the document (e.g., by visually pointing to or highlighting one or more portions of the document). In some embodiments, the messages may be associated with the document in other ways.

In some embodiments, the document may be a collaborative document including the messages (e.g., comments or edits) from collaborators. In some embodiments, the document may be generated for release to a second plurality of users. For example, the document may include release notes. Release notes may be drafted and disseminated following a software update or product launch. Release notes may outline changes, enhancements, and bug fixes that have been implemented since a past software version or earlier product. They may provide end-users, developers, or stakeholders with a concise overview of new features, improvements, resolved issues, or known problems that are yet to be addressed. These notes may facilitate better user understanding and adoption of the new changes, potentially reducing confusion and support queries. Moreover, release notes may include necessary acknowledgments or credits to contributors, along with guidance or recommendations for the installation or upgrade process, ensuring users have a smooth transition to the latest version. In some embodiments, the document may include other types of collaborative documents, such as shared documents in Google Drive or Microsoft 365, Wikis, project management tools, shared presentation tools, notetaking applications, online code editors such as GitHub or GitLab, shared digital whiteboards, or other collaborative workspaces. In some embodiments, a document may include text, images, tables, charts, graphs, hyperlinks, equations, videos, audio files, interactive elements, code, version history, checklists, or other elements.

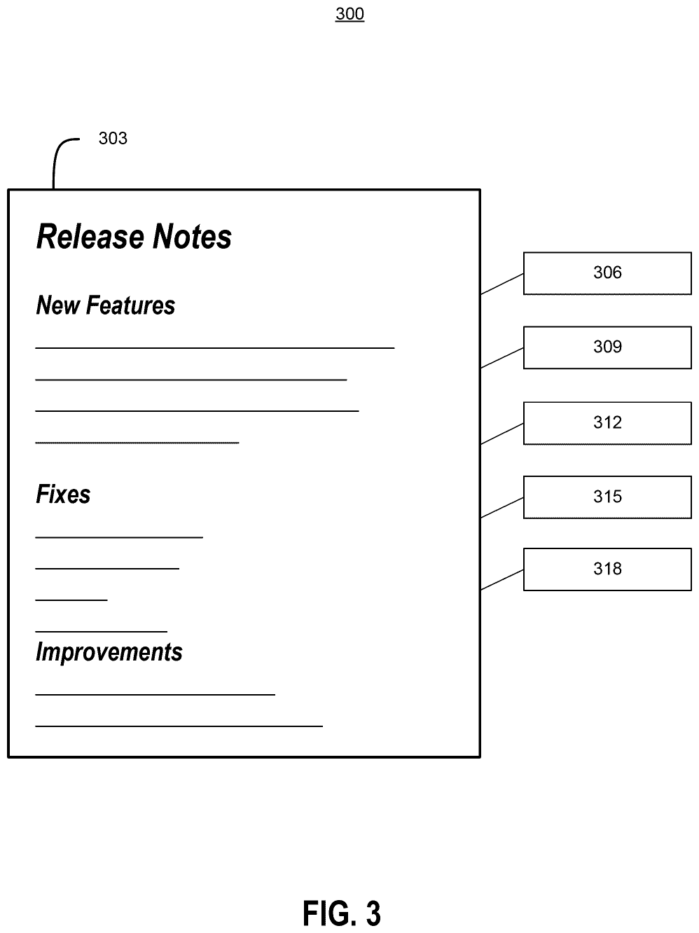

FIG. 3 illustrates a document 300 with messages associated with the document, in accordance with one or more embodiments. In some embodiments, document 300 may be a collaborative document, such as release notes 303. In some embodiments, release notes 303 may include one or more sections. In some embodiments, release notes 303 may include edits, revisions, or other annotations. For example, text within release notes 303 may be edited by one or more users. In some embodiments, document 300 may include one or more messages. For example, document 300 may include message 306, message 309, message 312, message 315, and message 318. Each message may be associated with a user (e.g., an author of the message). For example, message 306 and message 312 may be comments from a first user and message 309, message 315, and message 318 may be comments from a second user. In some embodiments, a message may refer to a portion of release notes 303 (e.g., a word, phrase, sentence, section, image, or other element). In some embodiments, a message may refer to release notes 303 as a whole. In some embodiments, a message may refer to another message. In some embodiments, a message may refer to an author of another message.

Machine learning subsystem 114 may determine, within a subset of the messages, one or more references. For example, machine learning subsystem 114 may use an NLP model to identify references within certain messages. In some embodiments, the one or more references may include pronouns, demonstratives, nominal phrases, or other references. An example of a reference may be “this” in the sentence “Let's remove this.” In some embodiments, each reference may refer to an antecedent. An antecedent may be a word, phrase, or clause to which a reference refers. The antecedent may give clarity to the pronoun, eliminating ambiguity by specifying the entity that the pronoun represents. In the example above, the antecedent to which “this” refers (in the sentence “Let's remove this”) may be a word, phrase, portion, image, or other element of a document.

In some embodiments, machine learning subsystem 114 may process the document and the messages that include references using a co-referencing model. In some embodiments, machine learning subsystem 114 may process the document and all messages associated with the document. As described above in relation to FIG. 2, the co-referencing model may be trained to predict antecedents based on references within text. The co-referencing model may determine an antecedent to which each reference in each message refers. The co-referencing model may predict an antecedent for a given reference by analyzing patterns and relationships within the document and messages. When the model receives, as input, a reference that appears to refer to something previously mentioned, it may scan the document and the messages to identify potential antecedents. This process may involve examining syntactic structures, such as subject-verb agreements, and semantic relationships, ensuring the reference and its antecedent align (e.g., in terms of number, gender, and role within a sentence). The co-referencing model may also leverage context, utilizing broader textual information to discern which entity the reference most likely refers to, especially in cases where multiple potential antecedents are present.

Machine learning subsystem 114 may determine, based on predictions generated by the co-referencing model, that both a first message and a second message refer to a particular antecedent. For example, machine learning subsystem 114 may determine that multiple messages—of the subset of messages that include references—refer to the same antecedent. In some embodiments, the antecedent may be a part of the document, a part of one of the messages, an author of one of the messages, or a different antecedent. In some embodiments, machine learning subsystem 114 may determine that multiple messages refer to the same antecedent by comparing predictions generated by the co-referencing model. For example, the co-referencing model may predict a particular antecedent for several references across several messages. In some embodiments, the co-referencing model may predict the particular antecedent with a high likelihood (e.g., satisfying a likelihood threshold). In some embodiments, the co-referencing model may predict the particular antecedent for several messages with a higher likelihood than other potential antecedents. In some embodiments, other methods of determining the antecedent based on the predictions from the co-referencing model may be used.

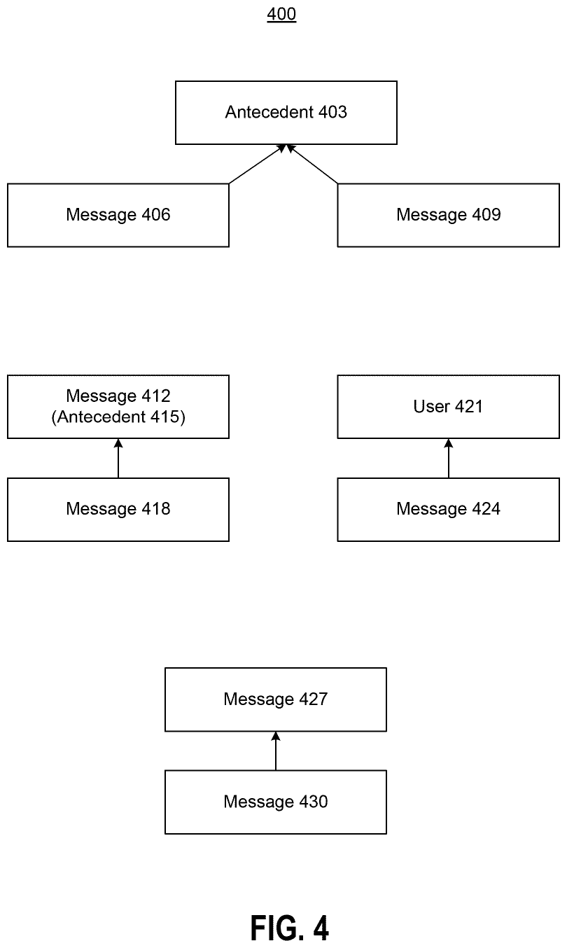

FIG. 4 illustrates relationships 400 between references and antecedents, in accordance with one or more embodiments. For example, relationships 400 may include a first message (e.g., message 406) and a second message (e.g., message 409) referring to the same antecedent (e.g., antecedent 403). As an illustrative example, message 406 may include “I don't know if we need the final part” and message 409 may include “Let's remove this.” The reference included in message 406 may be “the final part” and the reference included in message 409 may be “this.” Antecedent 403 may be a portion of the document, such as a final section, sentence, or other portion. Both “the final part” and “this” may refer to antecedent 403. In some embodiments, machine learning subsystem 114 may identify potentially redundant messages based on such a relationship as illustrated by message 406 and message 409.

In some embodiments, machine learning subsystem 114 may determine, based on predictions generated by the co-referencing model, that a message refers to a particular antecedent included within another message. For example, as shown in FIG. 4, message 418 may refer to antecedent 415 included in message 412. As an illustrative example, message 418 may include “I don't like the new title,” where “the new title” refers to antecedent 415. For example, message 412 may include “Can we change the title to Bug Fixes and Improvements?” and antecedent 415 may be “Bug Fixes and Improvements.” In some embodiments, machine learning subsystem 114 may identify potentially redundant messages based on such a relationship as illustrated by message 412 and message 418.

In some embodiments, machine learning subsystem 114 may identify potentially redundant messages based on other relationships between the messages. For example, machine learning subsystem 114 may determine, based on the predictions generated by the co-referencing model, that a third message refers to a user (e.g., a different user than the author of the third message). For example, the third message may include “I agree with John's suggestion,” and machine learning subsystem 114 may determine that “John” did not generate the third message. Machine learning subsystem 114 may determine that “John's suggestion” is a reference to a new antecedent. Returning to FIG. 4, message 424 (“I agree with John's suggestion”) may refer to user 421 (“John”). Machine learning subsystem 114 may determine one or more other messages generated by the user referenced in message 424 (e.g., John). For example, machine learning subsystem 114 may determine one or more other messages generated by user 421. Machine learning subsystem 114 may then determine a third meaning of the third message (e.g., message 424) and one or more other meanings of the one or more other messages generated by user 421 (e.g., using an NLP model). Similarity subsystem 116 may then compare the meanings and determine that the third meaning and at least one of the other meanings are within the threshold similarity of each other. Based on similarity subsystem 116 determining that the third meaning and at least one of the one or more other meanings are within the threshold similarity of each other, modification subsystem 118 may modify the document to remove the third message or one of the similar messages generated by the user (e.g., John) from the document. In some embodiments, machine learning subsystem 114 may identify potentially redundant messages based on such a relationship as illustrated by message 424 and user 421.

In some embodiments, machine learning subsystem 114 may determine, based on the predictions generated by the co-referencing model, that a third message refers to a fourth message. For example, as shown in FIG. 4, message 430 may refer to message 427. As an illustrative example, message 430 may include “I agree with the above suggestion,” with “the above suggestion” referring to message 427. Message 427 may include “Let's update the first section to include the new big fixes.” In some embodiments, machine learning subsystem 114 may identify potentially redundant messages based on such a relationship as illustrated by message 412 and message 418.

In some embodiments, machine learning subsystem 114 may determine the meanings associated with potentially redundant messages (e.g., messages referring to the same antecedent). In some embodiments, machine learning subsystem 114 may determine the meaning of a portion of each message that relates to the antecedent. For example, a message may include multiple subparts and some parts may not be relevant to the antecedent. As an illustrative example, a message may include “The document looks good overall, but I have some suggestions. I don't know if we need the final part.” Machine learning subsystem 114 may determine that “The document looks good overall, but I have some suggestions” is not relevant to the antecedent of “the final part.” Thus, machine learning subsystem 114 may determine the meaning of only a portion of the message, such as “I don't know if we need the final part.” For a first message and a second message both referring to a particular antecedent, machine learning subsystem 114 may determine a first meaning and a second meaning of the first message and the second message, respectively, relating to the particular antecedent.

In some embodiments, determining the first and second meanings involves processing, using a natural language processing model, the first and second messages. For example, initially, the NLP model may apply tokenization to each message, breaking down the text into individual words or tokens. Following tokenization, the NLP model may perform part-of-speech tagging, identifying whether a word functions as a noun, verb, adjective, etc. This step may reveal the role of each word within the sentence. Subsequently, the NLP model may apply named entity recognition to identify and categorize key entities within the messages, such as names of people, organizations, or locations. The NLP model may also use dependency parsing to analyze the grammatical structure of each sentence, establishing relationships between words. For semantic analysis, the NLP model may employ techniques such as word embeddings, which represent words in a high-dimensional space to capture their meanings based on context. By comparing these embeddings, the NLP model may infer the contextual meaning of words and phrases within each message. Finally, the NLP model may apply sentiment analysis to discern the emotional tone of each message or intent detection to understand the purpose behind the messages (e.g., whether a question is being asked or information is being provided).

Data condensing system 102 (e.g., similarity subsystem 116) may compare the meanings of the first and second messages. For example, the comparison may involve assessing the semantic similarity between the messages by comparing the vectors in their word embeddings, which encapsulate the contextual meanings of the words used. If the messages contain named entities or specific topics, similarity subsystem 116 may compare these elements to identify commonalities or differences in subject matter. Additionally, by analyzing the sentiment and intent behind each message, similarity subsystem 116 may determine if the first and second messages convey similar emotions or objectives. For instance, if both messages express a positive sentiment or ask a question, this may indicate a similarity in their purposes or tones. In some embodiments, similarity subsystem 116 may assign a similarity score based on one or more of these comparison techniques. In some embodiments, a similarity score may be a percentage (e.g., 0% similarity for completely different meanings to 100% similarity for identical meanings). In some embodiments, a similarity score may be a decimal (e.g., 0.0 for completely different meanings to 1.0 for identical meanings). In some embodiments, similarity subsystem 116 may use another method of assessing or scoring the similarity. In some embodiments, similarity subsystem 116 may compare the measure of similarity to a threshold similarity. For example, the threshold similarity may be predetermined and may be a minimum level of similarity at which two messages referring to the same antecedent are considered redundant or duplicative.

Similarity subsystem 116 may determine that the first meaning and the second meaning are within the threshold similarity of each other. For example, the similarity measure for the first and second messages may satisfy the threshold similarity. Based on determining that the first meaning and the second meaning are within a threshold similarity of each other, data condensing system 102 (e.g., modification subsystem 118) may modify the document to remove the one of the messages (e.g., the first message or the second message) from the document. For example, modification subsystem 118 may delete or hide the first message or the second message.

In some embodiments, modification subsystem 118 may select which message to remove based on an order of the messages. For example, modification subsystem 118 may remove the latter message in a temporal ranking (e.g., the second message if the second message was added to the document after the first message). In some embodiments, modification subsystem 118 may remove whichever message is located later sequentially in the document. In some embodiments, modification subsystem 118 may remove one of the messages based on one or more characteristics of the messages (e.g., from an NLP model). For example, modification subsystem 118 may remove a message based on the clarity of each message. In some embodiments, modification subsystem 118 may remove a message based on the extraneous details of each message. In some embodiments, modification subsystem 118 may remove a message based on the author of each message (e.g., seniority, role on a project associated with the document, or other characteristics of the author). In some embodiments, similarity subsystem 116 may determine that the first and second message are generated by two different users (e.g., the first message is generated by a first user and the second message is generated by a second user), and modification subsystem 118 may modify the document to remove one of the messages based on this determination. In some embodiments, if similarity subsystem 116 determines that the same author generated both messages, modification subsystem 118 may refrain from modifying the document to remove one of the messages. As an example, machine learning subsystem 114 may determine, based on the predictions generated by the co-referencing model, that both a third message and a fourth message refer to a new antecedent and are both generated by a third user. Based on determining that the third and fourth messages are both generated by the third user, modification subsystem 118 may refrain from modifying the document to remove the third message or the fourth message from the document.

In some embodiments, modification subsystem 118 may remove a message based on characteristics of the reference to the antecedent in each message. For example, modification subsystem 118 may remove the message having the vaguer reference to the antecedent. In an illustrative example, the first message may include “I don't know if we need the final part,” while a second message may include “Let's remove this.” Modification subsystem 118 may determine that “the final part” is less vague than “this,” so modification subsystem 118 may remove the second message. In some embodiments, the second message or a portion of the second message may point to or highlight a portion of the document. For example, the second message or a portion of the second message may be associated with a highlighted portion of the document. The reference of the second message may thus be less vague than the reference of the first message. Thus, modification subsystem 118 may remove the first message. In some embodiments, modification subsystem 118 may remove one or more messages based on a combination of these or other assessments.

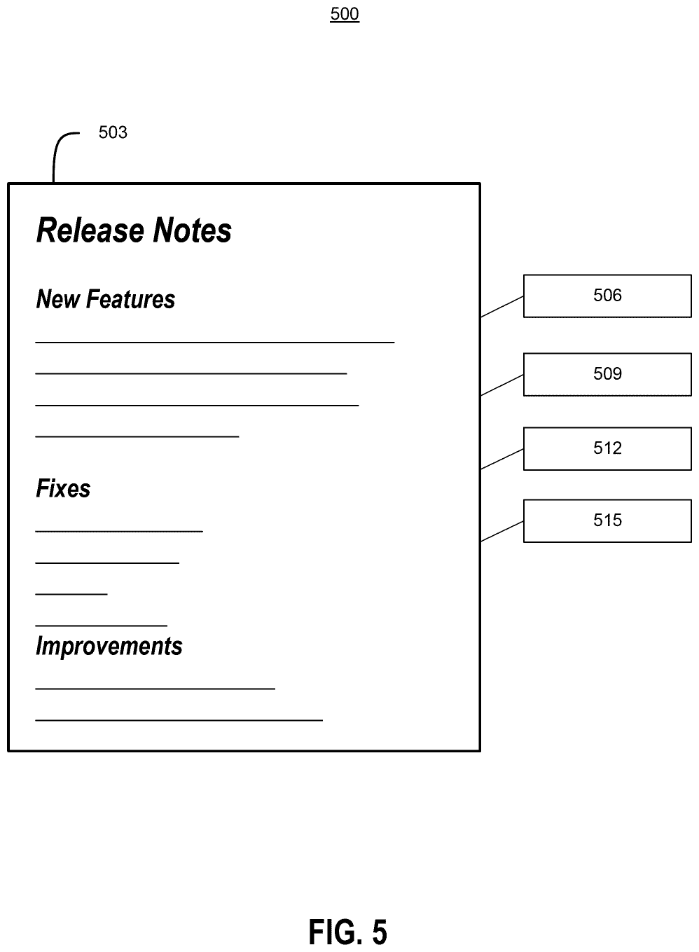

FIG. 5 illustrates a modified document 500 with messages associated with the modified document, in accordance with one or more embodiments. In some embodiments, modified document 500 may include a modified collaborative document, such as release notes 503. In some embodiments, modified document 500 may include one or more messages. For example, modified document 500 may include message 506, message 509, message 512, and message 515. In some embodiments, modified document 500 may be a modified version of document 300, as shown in FIG. 3. In some embodiments, document 300, as shown in FIG. 3, may be modified to remove one or more messages. As an illustrative example, a message (e.g., “Let's remove this”) may be removed from the document. Modified document 500 may thus include fewer redundancies than document 300.

In some embodiments, communication subsystem 112 may transmit the modified document. In some embodiments, the modified document may include the condensed messages. In some embodiments, communication subsystem 112 may transmit the modified document to first set of users (e.g., the users generating the messages). For example, the modified document may include the condensed messages and thus may be more easily interpreted. The first set of users may rely on the modified document for additional modifications to the document. In some embodiments, communication subsystem 112 may transmit the modified document to a second set of users. For example, communication subsystem 112 may disseminate the modified document to a different set of users than the first set of users. As an illustrative example, the second set of users may include users of the software or product associated with release notes, whereas the first set of users may include developers of the software or product.

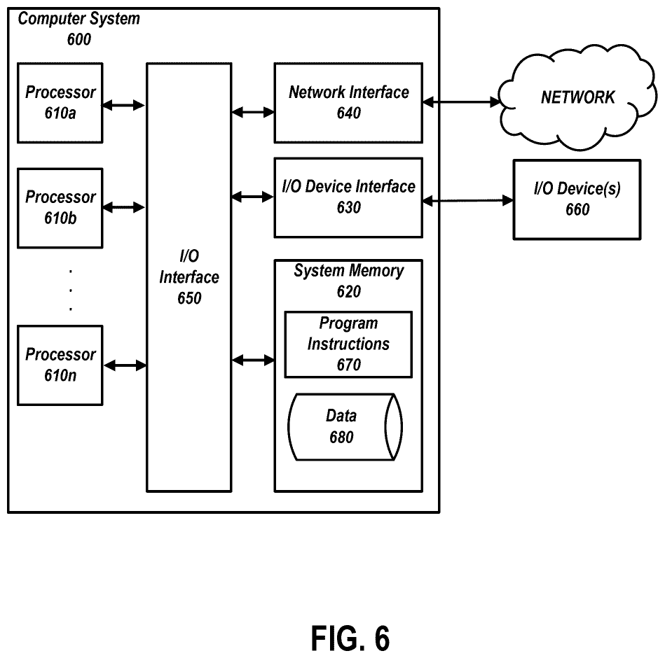

FIG. 6 shows an example computing system 600 that may be used in accordance with some embodiments of this disclosure. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computing system 600. Further, processes and modules described herein may be executed by one or more processing systems similar to that of computing system 600.

Computing system 600 may include one or more processors (e.g., processors 610a-610n) coupled to system memory 620, an input/output (I/O) device interface 630, and a network interface 640 via an I/O interface 650. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computing system 600 may be a uni-processor system including one processor (e.g., processor 610a), or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, for example., an FPGA (field-programmable gate array) or an ASIC (application-specific integrated circuit). Computing system 600 may include a plurality of computing devices (e.g., distributed computer systems) to implement various processing functions.

I/O device interface 630 may provide an interface for connection of one or more I/O devices 660 to computing system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computing system 600 through a wired or wireless connection. I/O devices 660 may be connected to computing system 600 from a remote location. I/O devices 660 located on remote computer systems, for example, may be connected to computing system 600 via a network and network interface 640.

Network interface 640 may include a network adapter that provides for connection of computing system 600 to a network. Network interface 640 may facilitate data exchange between computing system 600 and other devices connected to the network. Network interface 640 may support wired or wireless communication. The network may include an electronic communication network, such as the Internet, a local area network (LAN), a wide area network (WAN), a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 620 may include a tangible program carrier having program instructions stored thereon. A tangible program carrier may include a non-transitory, computer-readable storage medium. A non-transitory, computer-readable storage medium may include a machine-readable storage device, a machine-readable storage substrate, a memory device, or any combination thereof. A non-transitory computer-readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 620 may include a non-transitory computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 600, or multiple computer systems 600 configured to host different portions or instances of embodiments. Multiple computer systems 600 may provide for parallel or sequential processing/execution of one or more portions of the techniques described herein.

Those skilled in the art will appreciate that computing system 600 is merely illustrative and is not intended to limit the scope of the techniques described herein. Computing system 600 may include any combination of devices or software that may perform or otherwise provide for the performance of the techniques described herein. For example, computing system 600 may include or be a combination of a cloud-computing system, a data center, a server rack, a server, a virtual server, a desktop computer, a laptop computer, a tablet computer, a server device, a user device, a mobile telephone, a personal digital assistant (PDA), a mobile audio or video player, a game console, a vehicle-mounted computer, a GPS, or the like. Computing system 600 may also be connected to other devices that are not illustrated, or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

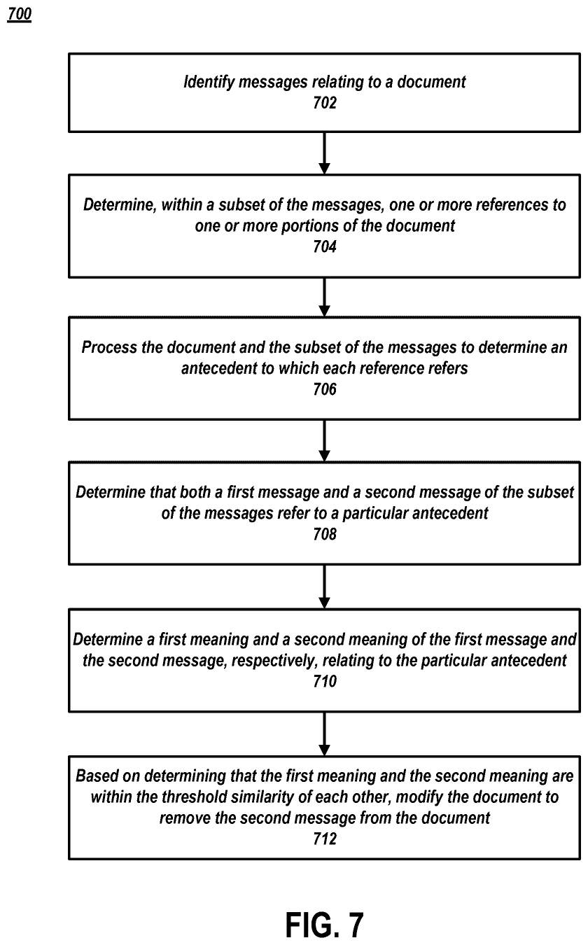

FIG. 7 shows a flowchart of the process 700 for condensing messages associated with release notes, in accordance with one or more embodiments. For example, the system may use process 700 (e.g., as implemented on one or more system components described above) to remove redundant messages from release notes.

At 702, data condensing system 102 (e.g., using one or more of processors 610a-610n) may identify messages relating to a document. For example, data condensing system 102 may identify messages generated by a first set of users within a document generated for release to a second set of users. In some embodiments, data condensing system 102 (e.g., communication subsystem 112) may identify the messages relating to the document using one or more of processors 610a-610n.

At 704, data condensing system 102 (e.g., using one or more of processors 610a-610n) may determine, within a subset of the messages, one or more references to one or more portions of the document. For example, the one or more references may include one or more of pronouns, demonstratives, and nominal phrases. The references may refer to one or more antecedents within the document or within other messages. In some embodiments, data condensing system 102 (e.g., machine learning subsystem 114) may determine the one or more references using one or more of processors 610a-610n.

At 706, data condensing system 102 (e.g., using one or more of processors 610a-610n) may process the document and the subset of the messages to determine an antecedent to which each reference refers. In some embodiments, data condensing system 102 may process the document and the subset of the messages using a co-referencing model. For example, the co-referencing model may be trained to predict antecedents based on references within text. In some embodiments, data condensing system 102 (e.g., machine learning subsystem 114) may process the document and the subset of the messages using one or more of processors 610a-610n.

At 708, data condensing system 102 (e.g., using one or more of processors 610a-610n) may determine that both a first message and a second message of the subset of the messages refer to a particular antecedent. For example, data condensing system 102 may determine that the first and second messages both refer to the particular antecedent based on predictions generated by the co-referencing model. In some embodiments, data condensing system 102 (e.g., machine learning subsystem 114) may determine that the first and second messages both refer to the particular antecedent using one or more of processors 610a-610n.

At 710, data condensing system 102 (e.g., using one or more of processors 610a-610n) may determine a first meaning and a second meaning of the first message and the second message, respectively, relating to the particular antecedent. For example, data condensing system 102 may use a natural language processing model to determine the first meaning and the second meaning. In some embodiments, data condensing system 102 (e.g., machine learning subsystem 114) may determine the first meaning and the second meaning using one or more of processors 610a-610n.

At 712, data condensing system 102 (e.g., using one or more of processors 610a-610n) may modify the document to remove the second message from the document. In some embodiments, data condensing system 102 may remove the second message from the document based on determining that the first meaning and the second meaning are within the threshold similarity of each other. In some embodiments, data condensing system 102 (e.g., modification subsystem 118) may modify the document using one or more of processors 610a-610n.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 7.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration and not of limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method comprising identifying, within a document generated for release to a second plurality of users, a plurality of messages from a first plurality of users, wherein the plurality of messages relates to the document, determining, within a subset of the plurality of messages, one or more references, wherein the one or more references comprise one or more of pronouns, demonstratives, and nominal phrases, processing, using a co-referencing model, the document and the subset of the plurality of messages to determine an antecedent to which each reference refers, wherein the co-referencing model is trained to predict antecedents based on references within text, determining, based on predictions generated by the co-referencing model, that both a first message and a second message of the subset of the plurality of messages refer to a particular antecedent; processing, using a natural language processing model, the first message and the second message to determine a first meaning and a second meaning, respectively, relating to the particular antecedent, based on determining that the first meaning and the second meaning are within a threshold similarity of each other, modifying the document to remove the second message from the document, and releasing the modified document to the second plurality of users.
2. A method comprising identifying, within a document, a plurality of messages relating to the document, determining, within a subset of the plurality of messages, one or more references to one or more portions of the document, processing, using a co-referencing model, the document and the subset of the plurality of messages to determine an antecedent to which each reference refers, wherein the co-referencing model is trained to predict antecedents based on references, determining, based on predictions generated by the co-referencing model, that both a first message and a second message of the subset of the plurality of messages refer to a particular antecedent; determining a first meaning and a second meaning of the first message and the second message, respectively, relating to the particular antecedent, determining that the first meaning and the second meaning are within a threshold similarity of each other, and based on determining that the first meaning and the second meaning are within the threshold similarity of each other, modifying the document to remove the second message from the document.
3. A method comprising identifying, within a document, a plurality of messages relating to the document, determining, within a subset of the plurality of messages, one or more references to one or more portions of the document, processing, using a co-referencing model, the document and the subset of the plurality of messages to determine an antecedent to which each reference refers, wherein the co-referencing model is trained to predict antecedents based on references, determining, based on predictions generated by the co-referencing model, that a first message of the subset of the plurality of messages refers to a particular antecedent included within a second message of the subset of the plurality of messages, determining a first meaning and a second meaning of the first message and the second message, respectively, relating to the particular antecedent, and based on determining that the first meaning and the second meaning are within a threshold similarity of each other, modifying the document to remove the first message from the document.
4. The method of any one of the preceding embodiments, wherein the plurality of messages is received from a first plurality of users.
5. The method of any one of the preceding embodiments, further comprising determining that the first message is generated by a first user of the first plurality of users and the second message is generated by a second user of the first plurality of users, wherein modifying the document to remove the second message from the document is performed further in response to determining that the first message is generated by the first user and the second message is generated by the second user.
6. The method of any one of the preceding embodiments, further comprising determining, based on the predictions generated by the co-referencing model, that a new antecedent to which a third message of the subset of the plurality of messages refers comprises a user of the first plurality of users, wherein the user did not generate the third message, determining one or more other messages, of the plurality of messages, generated by the user, determining a third meaning of the third message and one or more other meanings of the one or more other messages, determining that the third meaning and at least one of the one or more other meanings are within the threshold similarity of each other, and based on determining that the third meaning and at least one of the one or more other meanings are within the threshold similarity of each other, modifying the document to remove the third message from the document.
7. The method of any one of the preceding embodiments, further comprising determining, based on the predictions generated by the co-referencing model, that both a third message and a fourth message of the subset of the plurality of messages refer to a new antecedent, determining that the third message and the fourth message are both generated by a third user of the first plurality of users, and based on determining that the third message and the fourth message are both generated by the third user, refraining from modifying the document to remove the third message or the fourth message from the document.
8. The method of any one of the preceding embodiments, further comprising determining, based on the predictions generated by the co-referencing model, that a third message of the subset of the plurality of messages refers to a new antecedent included within a fourth message of the plurality of messages, determining a third meaning and a fourth meaning of the third message and the fourth message, respectively, relating to the new antecedent, determining that the third meaning and the fourth meaning are within the threshold similarity of each other, and based on determining that the third meaning and the fourth meaning are within the threshold similarity of each other, modifying the document to remove the third message from the document.
9. The method of any one of the preceding embodiments, further comprising determining, based on the predictions generated by the co-referencing model, that a third message of the subset of the plurality of messages refers to a fourth message of the plurality of messages, determining a third meaning and a fourth meaning of the third message and the fourth message, respectively, determining that the third meaning and the fourth meaning are within the threshold similarity of each other, and based on determining that the third meaning and the fourth meaning are within the threshold similarity of each other, modifying the document to remove the third message from the document.
10. The method of any one of the preceding embodiments, wherein the document is generated for release to a second plurality of users.
11. The method of any one of the preceding embodiments, further comprising releasing the modified document to the second plurality of users.
12. The method of any one of the preceding embodiments, wherein the one or more references comprise one or more of pronouns, demonstratives, and nominal phrases.
13. The method of any one of the preceding embodiments, wherein determining the first meaning and the second meaning of the first message and the second message, respectively, comprises processing, using a natural language processing model, the first message and the second message to determine the first meaning and the second meaning, respectively.
14. The method of any one of the preceding embodiments, further comprising determining that the first message is generated by a first user of the first plurality of users and the second message is generated by a second user of the first plurality of users, wherein modifying the document to remove the first message from the document is performed further in response to determining that the first message is generated by the first user and the second message is generated by the second user.
15. One or more tangible, non-transitory, computer-readable media storing instructions that, when executed by a data processing apparatus, cause the data processing apparatus to perform operations comprising those of any of embodiments 1-14.
16. A system comprising one or more processors and memory storing instructions that, when executed by the processors, cause the processors to effectuate operations comprising those of any of embodiments 1-14.
17. A system comprising means for performing any of embodiments 1-14.
18. A system comprising cloud-based circuitry for performing any of embodiments 1-14.

What is claimed is:

1. A system for condensing messages associated with software release notes, the system comprising:
one or more processors; and
one or more non-transitory, computer-readable media having computer-executable instructions stored thereon that, when executed by the one or more processors, causing the system to perform operations comprising:
identifying, within a document generated for release to a second plurality of users, a plurality of messages from a first plurality of users, wherein the plurality of messages relates to the document;
determining, within a subset of the plurality of messages, one or more references, wherein the one or more references comprise one or more of pronouns, demonstratives, and nominal phrases;
processing, using a co-referencing model, the document and the subset of the plurality of messages to determine an antecedent to which each reference refers, wherein the co-referencing model is trained to predict antecedents based on references within text;
determining, based on predictions generated by the co-referencing model, that both a first message and a second message of the subset of the plurality of messages refer to a particular antecedent;
processing, using a natural language processing model, the first message and the second message to determine a first meaning and a second meaning, respectively, relating to the particular antecedent;
based on determining that the first meaning and the second meaning are within a threshold similarity of each other, modifying the document to remove the second message from the document; and
releasing the modified document to the second plurality of users.

2. A method comprising:
identifying, within a document, a plurality of messages relating to the document;
determining, within a subset of the plurality of messages, one or more references to one or more portions of the document;
processing, using a co-referencing model, the document and the subset of the plurality of messages to determine an antecedent to which each reference refers, wherein the co-referencing model is trained to predict antecedents based on references;
determining, based on predictions generated by the co-referencing model, that both a first message and a second message of the subset of the plurality of messages refer to a particular antecedent;
determining a first meaning and a second meaning of the first message and the second message, respectively, relating to the particular antecedent;
determining that the first meaning and the second meaning are within a threshold similarity of each other; and
based on determining that the first meaning and the second meaning are within the threshold similarity of each other, modifying the document to remove the second message from the document.

3. The method of claim 2, wherein the plurality of messages is received from a first plurality of users.

4. The method of claim 3, further comprising determining that the first message is generated by a first user of the first plurality of users and the second message is generated by a second user of the first plurality of users, wherein modifying the document to remove the second message from the document is performed further in response to determining that the first message is generated by the first user and the second message is generated by the second user.

5. The method of claim 3, further comprising:
determining, based on the predictions generated by the co-referencing model, that a new antecedent to which a third message of the subset of the plurality of messages refers comprises a user of the first plurality of users, wherein the user did not generate the third message;
determining one or more other messages, of the plurality of messages, generated by the user;
determining a third meaning of the third message and one or more other meanings of the one or more other messages;
determining that the third meaning and at least one of the one or more other meanings are within the threshold similarity of each other; and
based on determining that the third meaning and at least one of the one or more other meanings are within the threshold similarity of each other, modifying the document to remove the third message from the document.

6. The method of claim 3, further comprising:
determining, based on the predictions generated by the co-referencing model, that both a third message and a fourth message of the subset of the plurality of messages refer to a new antecedent;
determining that the third message and the fourth message are both generated by a third user of the first plurality of users; and
based on determining that the third message and the fourth message are both generated by the third user, refraining from modifying the document to remove the third message or the fourth message from the document.

7. The method of claim 2, further comprising:
determining, based on the predictions generated by the co-referencing model, that a third message of the subset of the plurality of messages refers to a new antecedent included within a fourth message of the plurality of messages;
determining a third meaning and a fourth meaning of the third message and the fourth message, respectively, relating to the new antecedent;
determining that the third meaning and the fourth meaning are within the threshold similarity of each other; and
based on determining that the third meaning and the fourth meaning are within the threshold similarity of each other, modifying the document to remove the third message from the document.

8. The method of claim 2, further comprising:
determining, based on the predictions generated by the co-referencing model, that a third message of the subset of the plurality of messages refers to a fourth message of the plurality of messages;
determining a third meaning and a fourth meaning of the third message and the fourth message, respectively;
determining that the third meaning and the fourth meaning are within the threshold similarity of each other; and
based on determining that the third meaning and the fourth meaning are within the threshold similarity of each other, modifying the document to remove the third message from the document.

9. The method of claim 2, wherein the document is generated for release to a second plurality of users.

10. The method of claim 9, further comprising releasing the modified document to the second plurality of users.

11. The method of claim 2, wherein the one or more references comprise one or more of pronouns, demonstratives, and nominal phrases.

12. The method of claim 2, wherein determining the first meaning and the second meaning of the first message and the second message, respectively, comprises processing, using a natural language processing model, the first message and the second message to determine the first meaning and the second meaning, respectively.

13. One or more non-transitory, computer-readable media storing instructions that, when executed by one or more processors, cause operations comprising:
identifying, within a document, a plurality of messages relating to the document;
determining, within a subset of the plurality of messages, one or more references to one or more portions of the document;
processing, using a co-referencing model, the document and the subset of the plurality of messages to determine an antecedent to which each reference refers, wherein the co-referencing model is trained to predict antecedents based on references;
determining, based on predictions generated by the co-referencing model, that a first message of the subset of the plurality of messages refers to a particular antecedent included within a second message of the subset of the plurality of messages;
determining a first meaning and a second meaning of the first message and the second message, respectively, relating to the particular antecedent; and
based on determining that the first meaning and the second meaning are within a threshold similarity of each other, modifying the document to remove the first message from the document.

14. The one or more non-transitory, computer-readable media of claim 13, wherein the plurality of messages is received from a first plurality of users.

15. The one or more non-transitory, computer-readable media of claim 14, wherein the instructions further cause the one or more processors to perform operations comprising:
determining that the first message is generated by a first user of the first plurality of users and the second message is generated by a second user of the first plurality of users,
wherein modifying the document to remove the first message from the document is performed further in response to determining that the first message is generated by the first user and the second message is generated by the second user.

16. The one or more non-transitory, computer-readable media of claim 14, wherein the instructions further cause the one or more processors to perform operations comprising:
determining, based on the predictions generated by the co-referencing model, that a new antecedent to which a third message of the subset of the plurality of messages refers comprises a user of the first plurality of users, wherein the user did not generate the third message;
determining one or more other messages, of the plurality of messages, generated by the user;
determining a third meaning of the third message and one or more other meanings of the one or more other messages;
determining that the third meaning and at least one of the one or more other meanings are within the threshold similarity of each other; and
based on determining that the third meaning and at least one of the one or more other meanings are within the threshold similarity of each other, modifying the document to remove the third message from the document.

17. The one or more non-transitory, computer-readable media of claim 14, wherein the instructions further cause the one or more processors to perform operations comprising:
determining, based on the predictions generated by the co-referencing model, that both a third message and a fourth message of the subset of the plurality of messages refer to a new antecedent;
determining that the third message and the fourth message are both generated by a third user of the first plurality of users; and
based on determining that the third message and the fourth message are both generated by the third user, refraining from modifying the document to remove the third message or the fourth message from the document.

18. The one or more non-transitory, computer-readable media of claim 13, wherein the instructions further cause the one or more processors to perform operations comprising:
determining, based on the predictions generated by the co-referencing model, that a third message of the subset of the plurality of messages refers to a fourth message of the plurality of messages;
determining a third meaning and a fourth meaning of the third message and the fourth message, respectively;
determining that the third meaning and the fourth meaning are within the threshold similarity of each other; and
based on determining that the third meaning and the fourth meaning are within the threshold similarity of each other, modifying the document to remove the third message from the document.

19. The one or more non-transitory, computer-readable media of claim 13, wherein the one or more references comprise one or more of pronouns, demonstratives, and nominal phrases.

20. The one or more non-transitory, computer-readable media of claim 13, wherein determining the first meaning and the second meaning of the first message and the second message, respectively, comprises processing, using a natural language processing model, the first message and the second message to determine the first meaning and the second meaning.
